(19) United States
(12) Patent Application Publication
(10) Pub. No.: US 2026/0160936 A1
(43) Pub. Date: Jun. 11, 2026

(54) LIGHT GUIDE PLATE

(71) Applicant: HANNSTAR DISPLAY CORPORATION, Taipei City (TW)

(72) Inventors: Chen-Hao SU, Taipei City (TW); Chia-Feng TENG, Taipei City (TW); Chin-Yung LIU, Taipei City (TW)

(73) Assignee: HANNSTAR DISPLAY CORPORATION, Taipei City (TW)

(21) Appl. No.: 19/350,013

(22) Filed: Oct. 5, 2025

(30) Foreign Application Priority Data
Dec. 6, 2024 (TW) 113147573

(51) Int. Cl. F21V 8/00

(52) U.S. Cl. CPC G02B 6/0073; G02B 6/0018; G02B 6/0021; G02B 6/0038; G02B 6/0043

(57) ABSTRACT

The present invention provides a light guide plate comprising a body portion and a light incident structure. The body portion has opposite first and second optical surfaces. The light incident structure is disposed on a light-incident side of the body portion and is integrally formed. The light incident structure includes a first reflective inclined surface, a second reflective inclined surface, and a first through groove. The first reflective inclined surface is connected to the first optical surface, and the second reflective inclined surface is connected to the first inclined surface and the second optical surface. The first through groove is adjacent to the reflective inclined surfaces and extends through the body portion along the light incident side. An opening of the first through groove accommodates a light source. The first and second reflective inclined surfaces are configured to reflect light emitted from the light source into the body portion.

### CROSS REFERENCE TO RELATED APPLICATIONS

This application claims priority to Taiwan Application Serial Number 113147573, filed on Dec. 6, 2024, which is incorporated herein by reference.

### FIELD OF INVENTION

The present invention relates to a light guide structure, and more particularly to a light guide plate capable of directly converting a point light source into a uniform surface light source.

### BACKGROUND OF INVENTION

The primary function of a light guide plate is to convert light emitted from LEDs into a surface light source required by a display panel. However, when used with LED light strips, conventional light guide plates are prone to problems such as visible LED light shadows and uneven brightness. A common approach to address these issues involves incorporating dot patterns corresponding to the positions of the LEDs. Nevertheless, front light guide plates typically require highly directional dot designs, which complicates the optimization of light shadow correction. This challenge is further exacerbated in applications requiring wide viewing angles, resulting in reduced light uniformity and low light utilization efficiency.

### SUMMARY OF INVENTION

The object of the present invention is to provide a light guide plate that addresses the issues of light shadows and low light utilization on the light incident side of conventional light guide plates.

To achieve the above objective, the present invention provides a light guide plate. The light guide plate includes a body portion and a light incident structure. The body portion has a first optical surface and a second optical surface opposite to each other. The light incident structure is disposed on the light incident side of the body portion, and the body portion and the light incident structure are integrally formed as a single structure. The light incident structure includes a first reflective inclined surface, a second reflective inclined surface, and a first through groove. The first reflective inclined surface is connected to the first optical surface, and the second reflective inclined surface connects the first reflective inclined surface to the second optical surface. The first through groove is located adjacent to the first and second reflective inclined surfaces, extends along the extension direction of the light incident side, and passes through the body portion. At least one opening of the first through groove is configured to accommodate at least one light source. The first reflective inclined surface and the second reflective inclined surface are configured to reflect light emitted from the at least one light source into the body portion.

According to an embodiment of the present invention, an inner surface of the first through groove, which is located away from the first reflective inclined surface and the second reflective inclined surface, serves as a light incident surface of the body portion. An air interface is formed between the light incident surface and each of the first and second reflective inclined surfaces.

According to an embodiment of the present invention, the light incident structure further includes a second through groove, which is spaced apart from the first through groove. The second through groove penetrates through and extends from the first optical surface to the second optical surface, and is configured to refract light that enters the body portion from the first through groove.

According to an embodiment of the present invention, an inner surface of the first through groove, which is away from the first reflective inclined surface and the second reflective inclined surface, serves as a first light incident surface of the body portion. An inner surface of the second through groove, which is also away from the first reflective inclined surface and the second reflective inclined surface, serves as a second light incident surface of the body portion. An air interface is formed between the first light incident surface and the second light incident surface.

According to an embodiment of the present invention, the light incident structure is externally covered with a reflective sheet. The reflective sheet extends from a position covering the opening of the second through groove on the first optical surface, across the first reflective inclined surface and the second reflective inclined surface, to a position covering the opening of the second through groove on the second optical surface.

According to an embodiment of the present invention, the first through groove has two opposing openings respectively formed on two opposite side surfaces of the body portion, and the openings are configured to simultaneously accommodate at least one light source.

According to an embodiment of the present invention, a plurality of dimming structures are provided on all or part of the first reflective inclined surface and/or the second reflective inclined surface, in which each of the dimming structures is a dot structure, a prism structure, or a strip structure.

According to an embodiment of the present invention, the reflective capability of the dimming structures increases as the distance between the dimming structures and the at least one light source increases.

According to an embodiment of the present invention, the dimming structures are dot structures, prism structures, trapezoidal structures, or strip structures.

According to an embodiment of the present invention, the first reflective inclined surface and the second reflective inclined surface have different inclination angles.

As mentioned above, the light guide plate provided by the present invention includes two reflective inclined surfaces and a through groove extending along the light incident side. This design enables the light emitted from the point light source to be uniformly guided into the light guide plate. The incorporation of the through groove effectively addresses the conventional issues of poor compatibility between light sources and light guide plates, as well as the occurrence of light shadows at the light incident side, thereby enhancing the uniformity of light distribution on the incident side of the light guide plate.

### DESCRIPTION OF DRAWINGS

FIG. 1 is a schematic diagram illustrating a light guide plate applied to a display device according to an embodiment of the present invention.

FIG. 2 is a partial schematic view of a light guide plate according to an embodiment of the present invention.

FIG. 3 is a schematic view illustrating a light-guiding state of a light guide plate according to an embodiment of the present invention.

FIG. 4 is a schematic view illustrating a dimming structure according to an embodiment of the present invention.

FIGS. 5A to 5C are schematic views illustrating dimming structures according to different embodiments of the present invention.

### DETAILED DESCRIPTION OF PREFERRED EMBODIMENTS

In order to make the above and other objects, features, and advantages of the present invention more comprehensible, preferred embodiments of the present invention will be described below in detail together with the attached drawings. Furthermore, the directional terms used in the present invention, for example, up, down, top, bottom, front, back, left, right, inside, outside, side, around, central, horizontal, transverse, vertical, longitudinal, axial, radial direction, the uppermost layer, or the lowermost layer, etc. are only the directions shown in the attached drawings. Therefore, the directional terms are only used to illustrate and express the present invention, but not to limit the present invention.

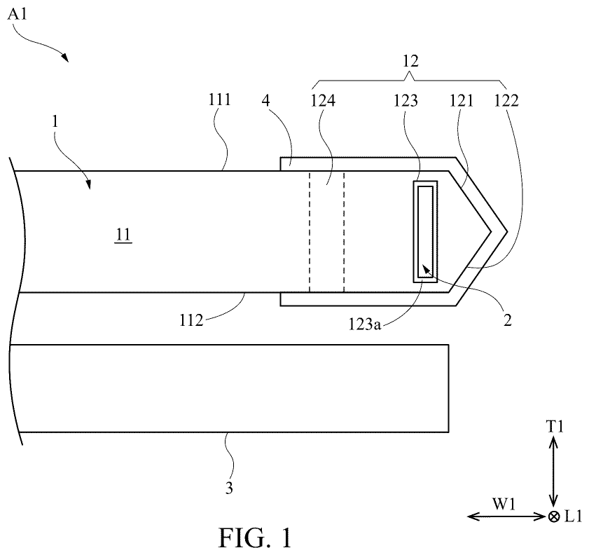

Referring to FIG. 1, which is a schematic diagram illustrating a light guide plate applied to a display device according to an embodiment of the present invention. The light guide plate of the present invention is configured to directly convert light emitted from at least one point light source into surface light, and is applicable to display devices. Specifically, the display device A1 shown in FIG. 1 mainly includes a light guide plate 1, at least one light source 2, and a display panel 3. The light guide plate 1 and the light source 2 together form a front light module, which is disposed on the viewing side of the display panel 3 to provide illumination for the display panel 3. In some embodiments, the display panel 3 may be a reflective display panel or a transflective display panel.

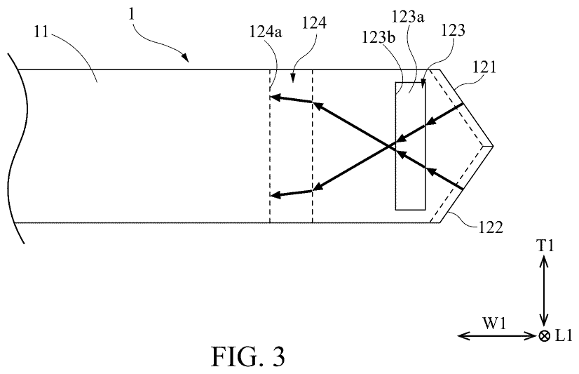

To facilitate the description of the overall structural configuration, a length direction L1, a width direction W1, and a thickness direction T1 of the light guide plate 1 are defined below. The length direction L1 refers to a direction along which light enters the light incident side of the light guide plate. For example, in FIGS. 1 and 3, the length direction L1 extends perpendicular to the plane of the drawing. The width direction W1 and the thickness direction T1 are both perpendicular to the length direction L1. For illustrative purposes, in FIGS. 1 and 3, the width direction W1 corresponds to the horizontal direction on the drawing plane, while the thickness direction T1 corresponds to the vertical direction. It should be noted that the aforementioned length direction L1, width direction W1, and thickness direction T1 are merely exemplary definitions for descriptive purposes, and these directional terms should not be construed as indicating the actual orientation of the light guide plate 1 during use.

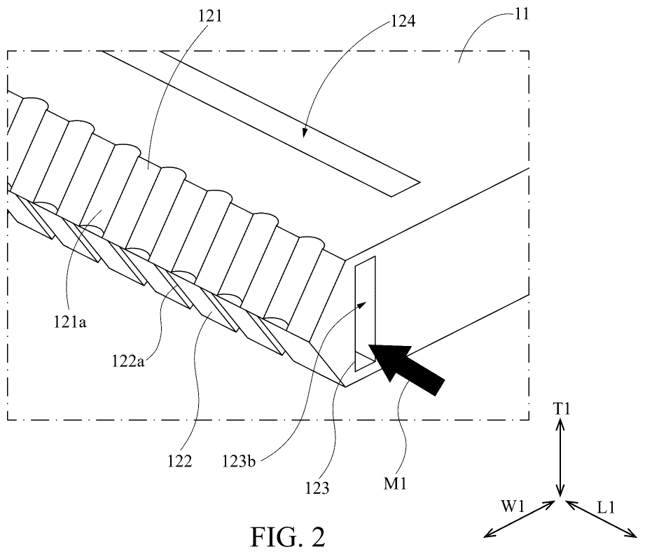

As shown in FIGS. 1 and 2, the light guide plate 1 includes a body portion 11 and a light incident structure 12, in which the body portion 11 and the light incident structure 12 are integrally formed as a single structure. The light incident structure 12 is disposed on the light incident side of the body portion 11 and is configured to direct light emitted from the light source into the body portion with improved distribution uniformity. In some embodiments, the light guide plate 1 may be made of a flexible material, such as silicone rubber or optical adhesive, and may be formed by a method such as lamination, 3D printing, or injection molding.

As shown in FIGS. 1 and 2, the body portion 11 has a first optical surface 111 and a second optical surface 112 opposite to each other. The light incident structure 12 includes a first reflective inclined surface 121, a second reflective inclined surface 122, a first through groove 123, and a second through groove 124. The first reflective inclined surface 121 is connected to the first optical surface 111, and the second reflective inclined surface 122 is connected to both the first reflective inclined surface 121 and the second optical surface 112. The first through groove 123 is located adjacent to the first reflective inclined surface 121 and the second reflective inclined surface 122. The first through groove 123 extends in the length direction L1 (i.e., the extension direction of the light-incident side) and penetrates through the body portion 11. In other words, the first through groove 123 extends through the body portion 11 from one side surface to the opposite side surface along the length direction L1. Corresponding openings 123a are formed on the opposite side surfaces of the body portion 11 in the length direction L1. The opening 123a is configured to accommodate the light source 2, such that light emitted from the light source 2 can enter the body portion 11 through the first through groove 123. In one embodiment, the light source 2 may include a single point light source or a plurality of point light sources, and is disposed at the opening 123a of the first through groove 123. The light source 2 may emit light M1 into the first through groove 123 along the length direction L1. In this embodiment, the first reflective inclined surface 121 and the second reflective inclined surface 122 are configured to reflect the light entering the first through groove 123 toward the body portion 11. In some embodiments, the first reflective inclined surface 121 and the second reflective inclined surface 122 may be formed with the same or different inclination angles, as required.

As shown in FIGS. 1 and 2, the second through groove 124 is spaced apart from the first through groove 123. The second through groove 124 extends through the body portion 11 from the first optical surface 111 to the second optical surface 112, along the thickness direction T1. The second through groove 124 is configured to refract the light entering the body portion 11 from the first through groove 123. In this embodiment, the first through groove 123 and the second through groove 124 extend through the body portion 11 in different directions. These through grooves define air interfaces within the body portion 11, allowing light to refract due to transmission between different media, thereby enhancing light uniformity on the light-incident side of the light guide plate. In one embodiment, as shown in FIG. 1, a reflective sheet 4 may cover the outside of the light incident structure 12. The reflective sheet 4 extends from a position covering the opening of the second through groove 124 on the first optical surface 111, across the first reflective inclined surface 121 and the second reflective inclined surface 122, to a position covering the opening of the second through groove 124 at the second optical surface 112. The reflective sheet 4 is configured to improve the light utilization efficiency at the light-incident side of the light guide plate.

Also referring to FIG. 3, specifically, the inner surface of the first through groove 123 that faces away from the first and second reflective inclined surfaces 121 and 122 is defined as a first light incident surface 123b of the body portion 11. The formation of the first through groove 123 results in an air interface between the first light incident surface 123b and the first and second reflective inclined surfaces 121 and 122. Similarly, the inner surface of the second through groove 124 that faces away from the first and second reflective inclined surfaces 121 and 122 is defined as the second light incident surface 124a of the body portion 11. The formation of the second through groove 124 also results in an air interface between the first light incident surface 123b and the second light incident surface 124a. Thus, as shown in FIGS. 2 and 3, when the light M1 provided by the light source enters the first through groove 123 along the length direction L1, a portion of the light passes through the second through groove 124 from the first light incident surface 123b and enters the body portion 11, while another portion is directed toward the first and second reflective inclined surfaces 121 and 122, reflected back into the first through groove 123, and subsequently enters the body portion 11 through the second through groove 124. Accordingly, as the light travels between different media, namely the air and the material of the body portion 11, it undergoes refraction, which improves its uniformity. After passing through the first and second through grooves and entering the body portion 11, the light travels along the width direction W1 and undergoes light extraction or reflection through the action of microstructures formed on the first optical surface 111 and the second optical surface 112.

In some embodiments, in order to improve light utilization and uniformity, a plurality of dimming structures 121a and 122a may be provided on all or part of the first reflective inclined surface 121 and the second reflective inclined surface 122. In this embodiment, the dimming structures 121a and the dimming structures 122a are respectively provided on the first reflective inclined surface 121 and the second reflective inclined surface 122, and are in the form of arc-shaped strips. In some embodiments, the reflective capability of the dimming structures 121a and 122a may be increased progressively with increasing distance from the light source 2. Specifically, as illustrated in FIGS. 1 and 2, the light M1 emitted from the light source 2 enters the first through groove 123 via the opening 123a and propagates inward. Due to optical attenuation over distance, regions farther from the light source 2 receive less illumination, resulting in reduced brightness compared to regions closer to the light source. Therefore, the dimming structures located farther from the light source 2 on the first and/or second reflective inclined surfaces 121 and 122 may be configured to have higher reflectivity than those positioned nearer to the light source 2.

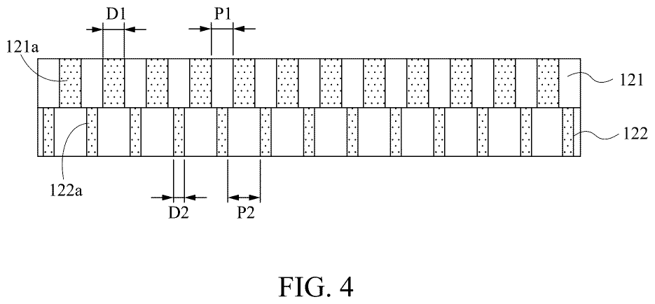

In some embodiments, different levels of reflectivity can be achieved by varying the density, presence, position, size, or shape of the dimming structures. For example, in areas farther from the light source 2, where brightness is lower, the dimming structures may be arranged more densely, designed with larger sizes, or selectively applied to enhance reflectivity. Conversely, in brighter areas closer to the light source 2, the dimming structures may be reduced in size or omitted to balance overall luminance. In the example of FIG. 4, the width D1 of each dimming structure 121a is greater than the width D2 of each dimming structure 122a, and the spacing P1 between adjacent dimming structures 121a is smaller than the spacing P2 between adjacent dimming structures 122a. Therefore, the reflective capability of the dimming structures 121a on the first reflective inclined surface 121 is greater than that of the dimming structures 122a on the second reflective inclined surface 122. It should be noted that FIG. 4 is provided merely to illustrate an example of how the arrangement and shape of the dimming structures can be used to achieve different reflective capabilities, and is not intended to limit the scope of the present invention. Such arrangements and adjustments in the reflective capabilities of the dimming structures may be applied to areas where a brightness difference exists between the first reflective inclined surface 121 and the second reflective inclined surface 122, in order to achieve improved light uniformity.

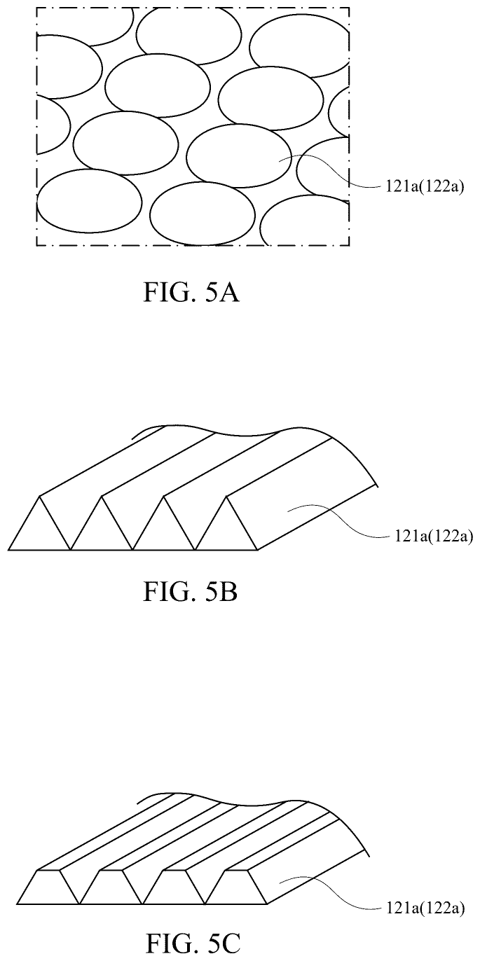

The dimming structures 121a and 122a of the present invention are not limited to circular arc-shaped designs. As shown in FIG. 5A, the dimming structures 121a and 122a may also be formed as dot patterns. Alternatively, as illustrated in FIG. 5B and FIG. 5C, the dimming structures 121a and 122a may be formed as triangular prism structures or trapezoidal prism structures.

In some embodiments, only the first through groove 123 may be provided without the second through groove 124, allowing light to propagate directly within the first through groove 123. A portion of the light that is directed toward the first and second reflective inclined surfaces 121 and 122 is reflected back into the first through groove 123 and then enters the body portion 11, thereby still achieving uniform light distribution.

From the above described embodiment of the present invention, it can be understood that the light guide plate includes two reflective inclined surfaces and a through groove structure extending along the light incident side. This design effectively guides light from a point light source uniformly into the light guide plate. The through groove structure addresses conventional issues such as the mismatch between traditional light sources and light guide plates and the appearance of light shadows at the light incident side, thereby improving the uniformity of light distribution at the light incident side of the light guide plate.

Although the present invention has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

1. A light guide plate, comprising:
a body portion having a first optical surface and a second optical surface opposite to each other; and
a light incident structure disposed on a light incident side of the body portion, wherein the body portion and the light incident structure are integrally formed as a single structure, and the light incident structure comprises:
a first reflective inclined surface connected to the first optical surface;
a second reflective inclined surface connected between the first reflective inclined surface and the second optical surface; and
a first through groove disposed adjacent to the first reflective inclined surface and the second reflective inclined surface, extending along an extension direction of the light incident side and passing through the body portion, wherein at least one opening of the first through groove is configured for accommodating at least one light source, and the first reflective inclined surface and the second reflective inclined surface are configured to reflect light emitted from the at least one light source into the body portion.

2. The light guide plate according to claim 1, wherein an inner surface of the first through groove, which is located away from the first reflective inclined surface and the second reflective inclined surface, is defined as a light incident surface of the body portion, and an air interface is formed between the light incident surface and both the first reflective inclined surface and the second reflective inclined surface.

3. The light guide plate according to claim 1, wherein the light incident structure further comprises a second through groove, which is spaced apart from the first through groove, and extends through the body portion from the first optical surface to the second optical surface, wherein the second through groove is configured to refract light that enters the body portion from the first through groove.

4. The light guide plate according to claim 3, wherein an inner surface of the first through groove that faces away from the first reflective inclined surface and the second reflective inclined surface serves as a first light incident surface of the body portion, and an inner surface of the second through groove that faces away from the first reflective inclined surface and the second reflective inclined surface serves as a second light incident surface of the body portion, wherein an air interface is formed between the first light incident surface and the second light incident surface.

5. The light guide plate according to claim 3, wherein the light incident structure is covered with a reflective sheet, which extends from a position covering the opening of the second through groove on the first optical surface, across the first reflective inclined surface and the second reflective inclined surface, to a position covering the opening of the second through groove on the second optical surface.

6. The light guide plate according to claim 1, wherein the first through groove has two opposing openings respectively formed on two opposite side surfaces of the body portion, and the openings are configured to accommodate at least one light source.

7. The light guide plate according to claim 1, wherein a plurality of dimming structures are provided on all or part of the first reflective inclined surface and/or the second reflective inclined surface.

8. The light guide plate according to claim 7, wherein the reflective capability of the dimming structures increases as the distance between the dimming structures and the at least one light source increases.

9. The light guide plate according to claim 7, wherein the dimming structures are dot structures, prism structures or strip structures.

10. The light guide plate according to claim 1, wherein the first reflective inclined surface and the second reflective inclined surface have different inclination angles.
